(19) United States
(12) Patent Application Publication
(10) Pub. No.: US 2006/0126739 A1
(43) Pub. Date: Jun. 15, 2006

(54) SIMD optimization for H.264 variable block size motion estimation algorithm

(76) Inventor: Michael D. Stoner, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/014,080

(22) Filed: Dec. 15, 2004

(51) Int. Cl. H04N 11/02; H04N 11/04; H04N 7/12; H04B 1/66

(52) U.S. Cl. 375/240.16; 375/240.24

(57) ABSTRACT

A method of optimizing the H.264 variable block-size motion estimation algorithm by using SIMD instructions to compute difference values for each microblock within a macroblock, and to determine the lowest difference value and corresponding motion vector for each microblock in all reference macroblocks in a search range.

### BACKGROUND

The present invention relates to the field of video encoding, and more particularly to the variable block size motion estimation algorithm in the H.264 encoding standard.

As technologies such as digital television and Internet video streaming proliferate, video compression is becoming an increasingly essential component in the distribution of digital media. The H.264 encoding standard provides better compression of video images as compared to previous encoding standards, which allows for better visual quality and compression in the encoded video stream.

According to the H.264 compression standard, each video “frame” within a sequence of frames are divided into a plurality of “macroblocks.” FIG. 1 illustrates how a current macroblock (120) in a second frame 2 (102) of a sequence is encoded using H.264. The pixel content of the current macroblock (120) is compared with the pixel content of macroblocks from one or more frames which have already been encoded, such as previously encoded reference macroblocks (104, 106, 108, 110, 112) in frame 1 (100). The H.264 algorithm determines which previously encoded reference macroblock is the closest match for the current macroblock, and records the positional difference between the current macroblock and the best reference macroblock as a motion vector. For example, where previously encoded reference macroblock (104) is the closest match for the current macroblock (120), a motion vector (114) is recorded. Any remaining pixel error between the two macroblocks is compressed into the bit stream by a subsequent phase of the encoder. The purpose of the motion estimation is to make this error as small as possible, leading to more compression in the encoded bit stream.

In earlier encoding standards, such as MPEG-2, only macroblocks of a fixed 16×16 size are compared during motion estimation. In H.264, however, a 16×16 macroblock is broken into many smaller blocks in hopes that the finer granularity will lead to a better match, and thus a greater compression ratio in the encoded stream.

FIG. 2 illustrates the subdivided 16×16 pixel macroblock used by the H.264 algorithm. Each previously encoded reference macroblock (i.e., FIG. 1 blocks 104, 106, 108, 110, 112) is divided into 41 blocks, sixteen 4×4 pixel blocks (202), eight 4×8 pixel blocks (204), eight 8×4 pixel blocks (206), four 8×8 pixel blocks (208), two 8×16 pixel blocks (210), two 16×8 pixel blocks (212), and one 16×16 pixel block. For the purpose of this disclosure, the 41 blocks (0-40) that make up a macroblock will be called “microblocks.”

In H.264, the motion estimation scheme measures error between two macroblocks by computing a Sum-of-Absolute-Differences (SAD) between the respective pixels in each block. The closest matching reference macroblock is one that produces the lowest SAD in comparison with the current macroblock. The SAD is computed for all 41 microblock combinations, rather than just for a single macroblock. This increases compression significantly, but also increases complexity of the encoder and time required for encoding. Thus, video encoding may be a more computationally intensive task using the H.264 standard. Encode times using H.264 are typically greater than those for earlier encoding standards, such as MPEG-2. By providing an efficient implementation of the integer search component of the H.264 motion estimation algorithm, the encoding time can be decreased.

### BRIEF DESCRIPTION OF THE DRAWINGS

A better understanding of the present invention can be obtained from the following detailed description in conjunction with the following drawings, in which:

FIG. 1 is a conceptual illustration of macroblock encoding using the H.264 encoding standard.

FIG. 2 is an illustration of the block combinations for each macroblock in the H.264 encoding standard.

FIG. 3 is a flow diagram illustrating a method for calculating sum-of-absolute-difference (SAD) values according to one embodiment of the present invention.

FIG. 4 is an illustration of SAD value calculations according to one embodiment of the present invention.

FIG. 5 is a flow diagram illustrating a method for comparing sum-of-absolute-difference (SAD) values according to one embodiment of the present invention.

FIG. 6 is an illustration of SAD value comparisons according to one embodiment of the present invention.

FIG. 7 is an illustration of a system block diagram according to one embodiment of the present invention.

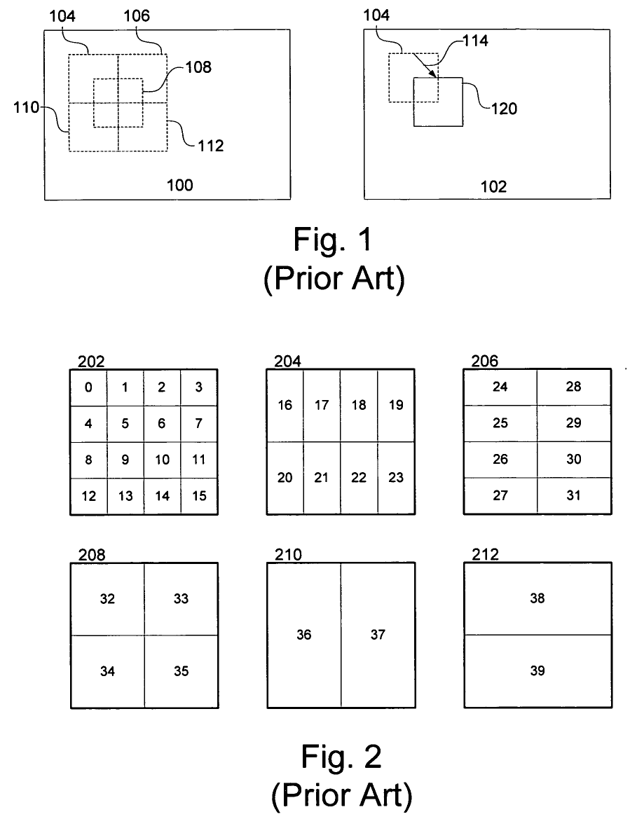

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed. For example, specific embodiments described herein describe the SAD (sum of absolute difference) method of computation to calculate difference values. One skilled in the art will recognize that other methods may be used to calculate the difference value according to other embodiments, including, but not limited to an SATD (sum of absolute transformed difference) function, a SSD (sum of squared difference) function, a MAD (mean of absolute difference) function, a Lagrange function, an average difference function, and a root mean squared difference function.

Embodiments of the present invention concern a system and method for optimizing the motion estimation algorithm used in an H.264 video encoder software application. In one embodiment, the optimized algorithm uses Streaming Single Instruction Multiple Data (SIMD) Extensions 2 (SSE2) instructions to operate on up to 16 pixels with a single instruction. SSE2 instructions operate on a set of eight XMM registers, which are 16 bytes in length.

In H.264, a sum-of-absolute-difference (SAD) value is computed for all 41 blocks for each reference macroblock in a predetermined search range. The results may be stored in an array of 41 integers, referred to herein as the “BestSAD” array, which represents the smallest SAD computed for each block combination. Another 41-element array, referred to herein as the “BestMV” array, contains the corresponding reference macroblock position, or motion vector, for each entry in the BestSAD array.

A pseudocode description of an algorithm for populating the BestSAD and BestMV arrays according to one embodiment of the present invention is given below:

Loop over search range of reference macroblocks (pRef)

Compute SAD'S for the sixteen 4 × 4 blocks within the

macroblock (comparing pCur and pRef)

Use 4 × 4 SAD'S and BlockList array to calculate SAD'S for

remaining 25 block combinations

(ThisSAD array now contains 41 SAD's for this reference

macroblock)

Loop over 41 block combinations

If ThisSAD[i] < BestSAD[i]

BestSAD[i] = ThisSAD[i]
BestMV[i] = MV for this reference macroblock

EndIf

EndLoop

End Loop

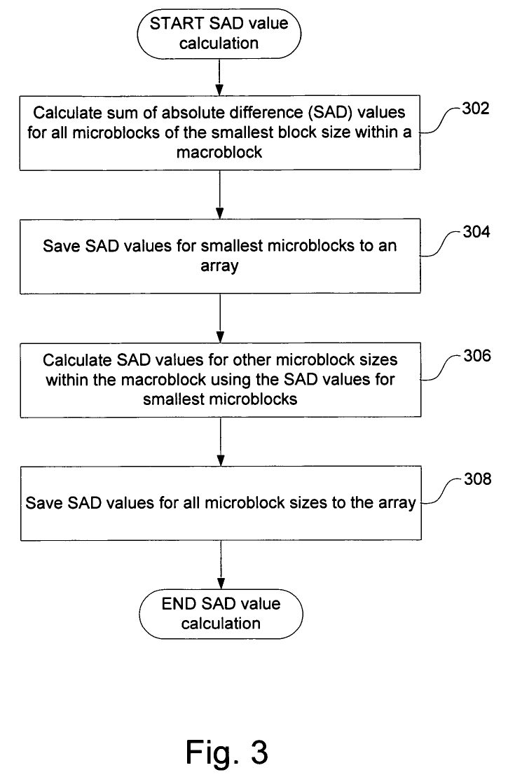

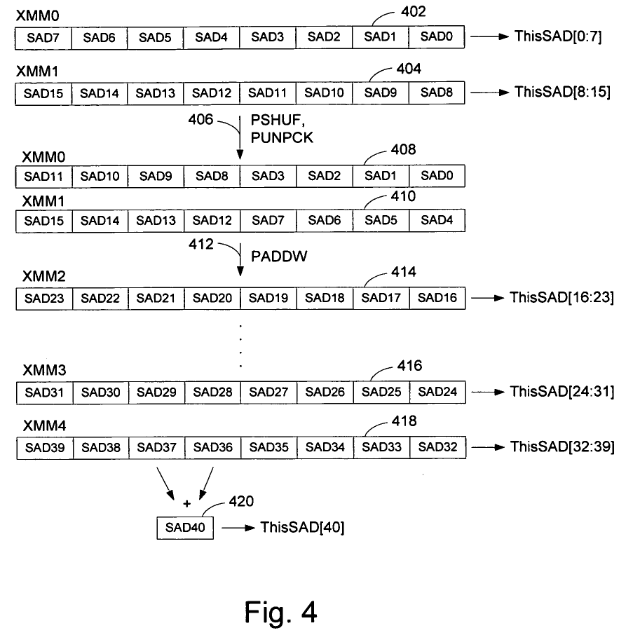

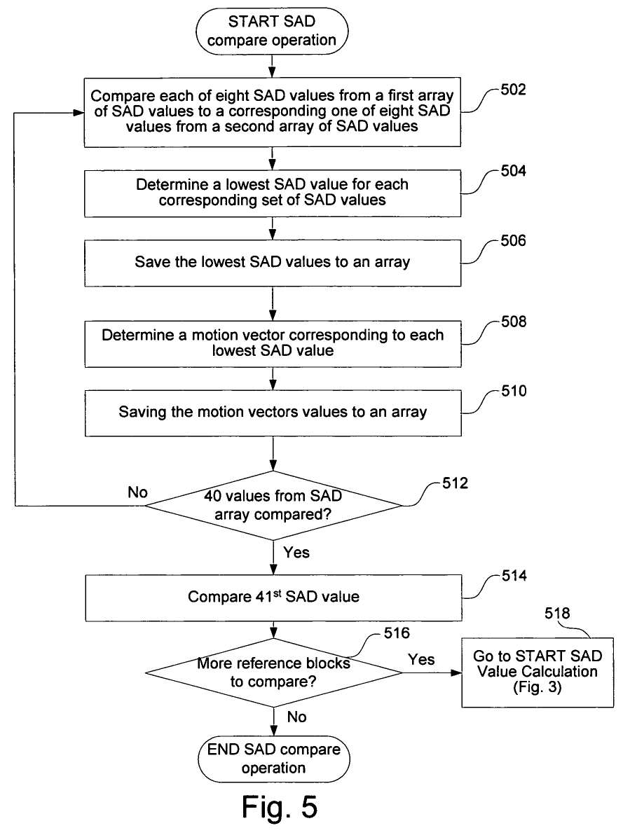

FIG. 3 is a flow diagram which illustrates a method by which SAD values for a macroblock may be calculated and stored according to one embodiment of the present invention. First, as shown in block 302, SAD values are calculated for all microblocks of the smallest block size within a macroblock. In one embodiment, SAD values are calculated for each of the sixteen 4×4 pixel microblocks within the macroblock. SAD values may be calculated for the 4×4 microblocks by determining the absolute value of the pixel value differences between the current block and the reference block for each pixel in the 4×4 microblock, and summing the absolute difference values for all pixels in the 4×4 microblock. In one embodiment, the SAD values may be calculated using the Compute Sum of Absolute Differences (PSADBW) instruction.

In one embodiment, the SAD values for the first eight of sixteen 4×4 pixel microblocks may be stored in one 16-byte register, such as a Streaming SIMD Extension (XMM) register, and the SAD values for the second eight of sixteen 4×4 pixel microblocks may be stored in another 16-byte register, such as an XMM register. In one embodiment, SSE2 instructions including Shift Packed Data Left Logical (PSLLQ), Bitwise Logical OR (POR), Add Packed Integers (PADDW), and Pack with Signed Saturation (PACKSSDW) may be used to place eight SAD values in one XMM register.

Next, as shown in block 304, the SAD values for the smallest microblocks within the macroblock are saved to an array. In one embodiment, the SAD values may be arranged in ascending numerical order before they are saved. In one embodiment, the first sixteen SAD values calculated are stored to positions 0 to 15 in an array, such as ThisSAD[0:15]. The array will ultimately contain forty-one SAD values, one SAD value for each microblock within the reference macroblock.

After the SAD values for the smallest microblocks within the macroblock have been calculated and stored, these values may be used to calculate the SAD values for microblocks of other sizes within the macroblock, as shown by block 306. In one embodiment, the SAD values for the smallest microblocks may be summed to calculate SAD values for larger microblocks in the macroblock. For example, referring to FIG. 2, the SAD value of 4×8 pixel microblock number 16 is the sum of the SAD values for 4×4 pixel microblocks numbers 0 and 4. Similarly, the SAD value of 8×8 pixel microblock number 32 is the sum of 4×8 pixel microblocks numbers 16 and 17 or the sum of 8×4 pixel microblocks numbers 24 and 25.

In one embodiment, the SAD values of the larger microblocks may be calculated from the SAD values of the smaller microblocks by reordering the SAD values in the two XMM registers and adding the values together. This may be achieved using the Shuffle Packed Doublewords (PSHUF), Unpack Data (PUNPCK), and Add Packed Integers (PADDW) instructions.

Finally, after the SAD values for the larger microblocks are calculated, they are stored to the array. In one embodiment, the SAD values may be stored to the array 16 bytes at a time. Thus, the SAD values for each of the 41 microblocks in the reference macroblock are stored in an array.

In this manner, SAD values may be calculated for each of the microblocks in every reference macroblock in the search range for a current macroblock.

A pseudocode description of an optimized algorithm for calculating SAD values using Streaming Single Instruction Multiple Data (SIMD) Extensions 2 (SSE2) instructions according to one embodiment of the present invention is given below:

SAD16×16B1ock_H264(pCur, pRef, ThisSAD)

Loop:

compute eight 4×4 SAD'S (0-7 in 1^{st} iteration, 8-15
in 2^{nd} iteration)
(uses PSADBW, PSLLQ, POR, PADDW, PACKSSDW
to end up
with eight SAD values in one XMM register)

EndLoop
(xMM0 - SAD'S 0-7, XMM1 - SAD'S 8-15)
Use PSHUF, PUNPCK, PADDW to compute remaining 25 SAD's

from 4×4 SAD'S
Save SAD data (16 bytes at a time) to ThisSAD array

FIG. 4 illustrates an example calculation of SAD values for a macroblock using SSE2 instructions according to one embodiment of the present invention. SAD values for 4×4 microblocks 0-7 are calculated and stored in register XMM0 (402). These values are also stored in array ThisSAD[0:7]. Similarly, SAD values for 4×4 microblocks 8-15 are calculated and stored in register XMM1 (404). These values also are stored in array ThisSAD[8:15].

The SAD values in registers XMM0 and XMM1 are then rearranged using the PSHUF and PUNPCK instructions (406). XMM0 and XMM1 now contain reordered SAD values (408, 410), which are added together using the PADDW instruction (412) to determine SAD values for microblocks 16-23. SAD values for microblocks 16-23 are placed in the XMM2 register, and are also stored in the array ThisSAD[16:23].

The SAD values in the XMM registers are further reordered and added until 40 SAD values have been calculated. SAD values 24-31 are placed in an XMM register and stored in the array ThisSAD[24:31] (416), and SAD values 32-39 are placed in an XMM register and stored in the array ThisSAD[32:39] (418). To calculate the final SAD value, the SAD values for microblocks 36 and 37 or microblocks 38 and 39 may be added together (420). The 41st SAD value may be stored in array ThisSAD[40].

After all of the SAD values have been calculated for each of the 41 microblocks in a macroblock, the smallest SAD value for each microblock must be determined. Thus, the smallest SAD value calculated for microblock 0 in all reference macroblocks must be determined, and so on for each of microblocks 0-40. The motion vector corresponding to the smallest SAD value for each microblock is also determined.

FIG. 5 is a flow diagram which illustrates a method by which the smallest SAD value for each microblock in all reference macroblocks and its corresponding motion vector may be calculated and stored according to one embodiment of the present invention.

First, as illustrated in block 502, each of eight SAD values from a first array of SAD values is compared to a corresponding one of eight SAD values from a second array of SAD values. In one embodiment, the eight SAD values from the first array of SAD values may be stored in a 16-byte register, such as an XMM register. The eight SAD values from the second array of SAD values may also be stored in a 16-byte register, such as an XMM register. In one embodiment, the first and second sets of SAD values which are each stored in an XMM register may then be compared using a Compare Packed Signed Integers for Greater Than (PCMPGTW) instruction. Using the PCMPGTW instruction results in a compare mask of ones and zeros.

Next, a lowest SAD value is determined for each corresponding set of SAD values, as shown in block 504. In one embodiment, Logical AND (PAND), Logical NAND (PNAND), and/or Logical OR (POR) instructions may be used to determine the lowest SAD value based on the compare mask and the contents of the XMM registers.

Once the lowest SAD value has been determined for each corresponding set of SAD values, it is saved to an array of best SAD values, as shown in block 506. The motion vector corresponding to each lowest SAD value is determined, as shown in block 508. The motion vector corresponding to each lowest SAD values is than saved to an array of best motion vector values, as shown in block 510.

Next, as shown in block 512, if the first 40 of 41 values in the SAD array have not yet been compared, then the next eight elements in each array are compared (block 502). In one embodiment, the loop from blocks 502 to 512 may be repeated five times to compare the first 40 elements of each SAD array. If the first 40 values have been compared, then the 41st SAD value is compared and the lowest value is saved to the array of best SAD values as shown in block 514. In one embodiment, the 41st SAD may be handled using scalar x86 instructions. The motion vector corresponding to the final lowest SAD value is also saved to an array of best motion vector values.

Finally, if there are no more reference blocks in the search range to compare, as determined in block 518, the operation is complete. If more reference blocks exist, then the SAD values must be calculated for the next reference block, as shown by block 520.

A pseudocode description of an optimized algorithm for determining the best SAD values for each microblock and determining the corresponding motion vectors using SSE2 instructions according to one embodiment of the present invention is given below:

SADComp41(ThisSAD, BestSAD, BestMV, RefXY)

Loop (5 times):

Use PCMPGTW to compare 8 SAD's at time from BestSAD
& ThisSAD arrays
(results in compare mask of 1's and 0's)
Use PAND/PNAND/POR to propagate the lowest (best)
SAD from each comparison
Use PAND/PNAND/PQR to propagate the motion vector
corresponding to the best SAD

EndLoop
If (ThisSAD[40] < BestSAD[40])

BestSAD[40] = ThisSAD[40]
BestMV[40] = RefMV (motion vector for pRef)

EndIf

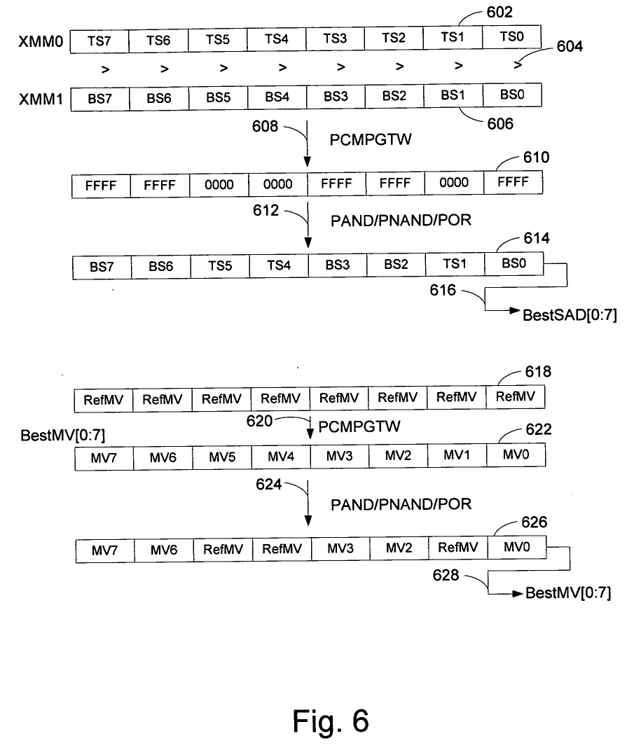

FIG. 6 illustrates an example calculation of SAD values for a macroblock using SSE2 instructions according to one embodiment of the present invention. Eight SAD values from a first array, are stored in a 16-byte register, XMM0 (602). Eight corresponding SAD values from a second array are stored in a second 16-byte register, XMM1 (606). In one embodiment, TS[0:7] represent the SAD values calculated for microblocks 0-7 of the current reference macroblock. BS[0:71] represent the lowest SAD values for microblocks 0-7 found thus far. Each of the values in the first register (602) are compared (604, 608) to a corresponding value in the second register (606). The result of the compare operation is a compare mask of ones and zeros (610). Using the compare mask and PAND/PNAND/POR instructions, the lowest SAD value for each corresponding set of SAD values is determined (614) and stored in an array, BestSad[0:7] (616).

After the lowest SAD values have been determined, the corresponding motion vectors are determined. In one embodiment, the corresponding motion vectors may be determined by using the compare mask (610) generated previously and PAND/PNAND/POR instructions (624) to obtain the motion vectors which correspond to SAD values (614). The motion vectors may then be stored to an array of motion vectors, BestMV[0:7] (628).

As described above, this process may be repeated until a lowest SAD value and corresponding motion vector has been determined for each of the 41 microblocks in a given reference block.

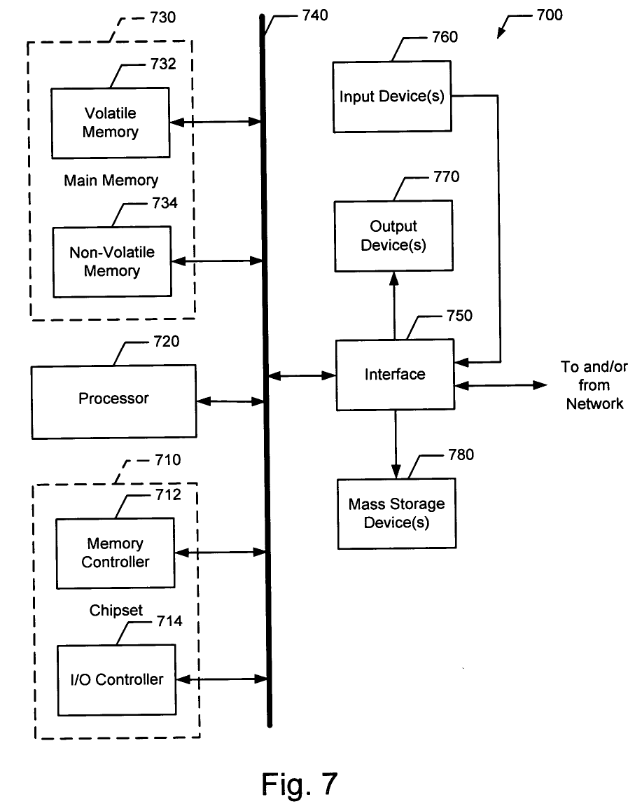

FIG. 7 is a block diagram of an example system (700) adapted to implement the methods disclosed herein. The system (700) may be a desktop computer, a laptop computer, a notebook computer, a personal digital assistant (PDA), a server, a workstation, a cellular telephone, a mobile computing device, an Internet appliance or any other type of computing device.

The system (700) includes a chipset (710), which may include a memory controller (712) and an input/output (I/O) controller (714). A chipset typically provides memory and I/O management functions, as well as a plurality of general purpose and/or special purpose registers, timers, etc. that are accessible or used by a processor (720). The processor (720) may be implemented using one or more processors.

The memory controller (712) may perform functions that enable the processor (720) to access and communicate with a main memory (730) including a volatile memory (732) and a non-volatile memory (734) via a bus (740).

The volatile memory (732) may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory (534) may be implemented using flash memory, Read Only Memory (ROM), Electrically Erasable Programmable Read Only Memory (EEPROM), and/or any other desired type of memory device.

Memory (730) may be used to store information and instructions to be executed by the processor (720). Memory (730) may also be used to store temporary variables or other intermediate information while the processor (720) is executing instructions.

The system (700) may also include an interface circuit (750) that is coupled to bus (740). The interface circuit (750) may be implemented using any type of well known interface standard such as an Ethernet interface, a universal serial bus (USB), a third generation input/output interface (3GIO) interface, and/or any other suitable type of interface.

One or more input devices (760) are connected to the interface circuit (750). The input device(s) (760) permit a user to enter data and commands into the processor (720). For example, the input device(s) (760) may be implemented by a keyboard, a mouse, a touch-sensitive display, a track pad, a track ball, and/or a voice recognition system.

One or more output devices (770) may be connected to the interface circuit (750). For example, the output device(s) (770) may be implemented by display devices (e.g., a light emitting display (LED), a liquid crystal display (LCD), a cathode ray tube (CRT) display, a printer and/or speakers). The interface circuit (750), thus, typically includes, among other things, a graphics driver card.

The system (700) also includes one or more mass storage devices (580) to store software and data. Examples of such mass storage device(s) (780) include floppy disks and drives, hard disk drives, compact disks and drives, and digital versatile disks (DVD) and drives.

The interface circuit (750) may also include a communication device such as a modem or a network interface card to facilitate exchange of data with external computers via a network. The communication link between the system (500) and the network may be any type of network connection such as an Ethernet connection, a digital subscriber line (DSL), a telephone line, a cellular telephone system, a coaxial cable, etc.

Access to the input device(s) (760), the output device(s) (770), the mass storage device(s) (780) and/or the network is typically controlled by the I/O controller (714) in a conventional manner. In particular, the I/O controller (714) performs functions that enable the processor (720) to communicate with the input device(s) (760), the output device(s) (770), the mass storage device(s) (780) and/or the network via the bus (740) and the interface circuit (750).

While the components shown in FIG. 5 are depicted as separate blocks within the system (700), the functions performed by some of these blocks may be integrated within a single semiconductor circuit or may be implemented using two or more separate integrated circuits. For example, although the memory controller (712) and the I/O controller (714) are depicted as separate blocks within the chipset (710), persons of ordinary skill in the art will readily appreciate that the memory controller (712) and the I/O controller (714) may be integrated within a single semiconductor circuit.

By applying Single Instruction Multiple Data (SIMD) operations, such as Streaming SIMD Extensions 2 (SSE2) instructions, as described herein, the integer search component of the H.264 motion estimation algorithm can be sped up by a factor of five. In a typical H.264 implementation, this may cut the overall encoding time nearly in half.

The methods set forth above may be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, a method, machine readable medium, and system to optimize the motion estimation algorithm used in an H.264 video encoder software application are disclosed. In the above description, numerous specific details are set forth. However, it is understood that embodiments may be practiced without these specific details. For example, specific embodiments have been described as using combinations of registers and memory to store information such as SAD values. It will be recognized that if enough registers are available, it may not be necessary to store information to memory in an array. In other instances, well-known circuits, structures, and techniques have not been shown in detail in order not to obscure the understanding of this description. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

I claim:

1. A method comprising:
calculating a first set of difference values for a first plurality of microblocks within a first reference macroblock;
storing the first set of difference values in a first register;
calculating a second set of difference values for a second plurality of microblocks within a first reference macroblock; and
storing the second set of difference values in a second register.

2. The method of claim 1, wherein the first set of difference values and the second set of difference values are sum of absolute difference (SAD) values.

3. The method of claim 1, wherein the first register and the second register are XMM registers.

4. The method of claim 1, wherein each of the first plurality microblocks and each of the second plurality of microblocks has dimensions of 4 pixels by 4 pixels.

5. The method of claim 2, further comprising:
calculating a predetermined number of additional SAD values from the first set of SAD values and the second set of SAD values; and
saving the first set of SAD values, the second set of SAD values, and the predetermined number of additional SAD values to a first array.

6. The method of claim 5, wherein the predetermined number of additional SAD values is 25.

7. The method of claim 5, wherein the array contains 41 SAD values.

8. The method of claim 5, further comprising calculating a set of SAD values for a second reference macroblock and saving the set of SAD values to a second array.

9. The method of claim 8, further comprising comparing each SAD value element in the first array to a corresponding SAD value element in the second array to determine a lowest SAD value for each element, and storing the lowest SAD value for each element in a corresponding element of the second array.

10. The method of claim 9, further comprising determining a motion vector value corresponding to each lowest SAD value in the second array and storing the motion vector value in a corresponding element of a third array.

11. A method comprising:
(a) performing a compare operation to compare each of a first plurality of difference values from a first array of difference values to a corresponding one of a second plurality of difference values from a second array of difference values;
(b) determining a lowest difference value for each corresponding set of difference values;
(c) saving each lowest difference value to the second array of difference values;
(d) determining a motion vector corresponding to each lowest difference value; and
(e) saving each motion vector to an array of motion vectors.

12. The method of claim 11, wherein each difference value is a SAD value.

13. The method of claim 12, wherein the first plurality of SAD values comprises eight SAD values and the second plurality of SAD values comprises eight SAD values.

14. The method of claim 12, wherein each SAD value is one word, the first array of SAD values contains 41 SAD values, and the second array of SAD values contains 41 SAD values.

15. The method of claim 13, wherein performing the compare operation comprises executing a PCMPGTW instruction.

16. The method of claim 15, wherein determining a lowest SAD value for each corresponding set of SAD values comprises executing a PAND, a PNAND, and a POR instruction.

17. The method of claim 16, wherein determining a motion vector corresponding to each lowest SAD value comprises executing a PAND, a PNAND, and a POR instruction.

18. The method of claim 12, further comprising repeating steps (a) through (e) four times.

19. The method of claim 18, further comprising comparing a final SAD value in the first array of SAD values to a final element in the second array of SAD values, determining a final lowest SAD value and saving it to the second array of SAD values, determining a final motion vector corresponding to the final lowest SAD value, and saving the final motion vector to the array of motion vectors.

20. An article of manufacture comprising a machine-accessible medium having stored thereon instructions which, when executed by a machine, cause the machine to:
calculate difference values for all microblocks of the smallest block size within a reference macroblock;
save the difference values for all microblocks of the smallest block size to a first array;
calculate difference values for other microblock sizes with the reference macroblock using the difference values for all microblocks of the smallest block size;
save the difference values of other microblock sizes to the first array;
compare each of a first plurality of difference values from the first array to a corresponding one of a second plurality of difference values from a second array to determine a lowest difference value for each corresponding set of difference values; and
saving the lowest difference value for each corresponding set of difference values to the second array.

21. The article of manufacture of claim 20, wherein the instructions further cause the machine to determine a motion vector corresponding to each lowest difference value and save each motion vector to a third array.

22. The article of manufacture of claim 20, wherein each difference value is a SAD value.

23. A system, comprising:
a bus;
a processor coupled to the bus; and
memory coupled to the processor, the memory adapted for storing instructions, which upon execution by the processor, cause:
(a) difference values to be calculated for all microblocks within a reference macroblock;
(b) the difference values to be stored to a first array;
(c) a first plurality difference values from the first array to be compared to a corresponding of a second plurality of difference values from a second array to determine a lowest difference value for each of a corresponding set of difference values;
(d) saving the lowest difference value for each corresponding set of difference values to the second array; and
(e) determining a motion vector corresponding to each lowest difference value and saving each motion vector to a third array.

24. The system of claim 23, wherein the instructions, upon execution by the processor, further cause steps (a) through (e) to be repeated for each of a plurality of reference blocks.

25. The system of claim 24, wherein each difference value is a SAD value.
